(19) United States
(12) Patent Application Publication
(10) Pub. No.: US 2026/0208227 A1
(43) Pub. Date: Jul. 23, 2026

(54) METHOD OF EMPTYING A CARTRIDGE

(71) Applicant: medmix Switzerland AG, Haag (Rheintal) (CH)

(72) Inventors: Tobias BODENMÜLLER, Eriskirch (DE); Rico ITEN, Sevelen (CH); Philipp SEILER, St. Gallen (CH); Christian MAJOLETH, Bonaduz (CH); Ralf GRÜNENFELDER, Wangs (CH); Wolfgang KITZMÜLLER, Wolfurt (AT)

(21) Appl. No.: 19/139,506

(22) PCT Filed: Nov. 2, 2023
(86) PCT No.: PCT/EP2023/080555

§ 371 Date: Jun. 16, 2025

(30) Foreign Application Priority Data
Dec. 23, 2022 (GB) 2219666.1

(51) Int. Cl. B05C 17/005

(52) U.S. Cl. CPC B05C 17/00503; B05C 17/0052; B05C 17/00579

(57) ABSTRACT

A method of emptying a cartridge to be recycled includes providing a cartridge filled with a volume amount of a residual material to be removed from the cartridge, the cartridge comprising a solid head part having an outlet part forming an outlet, and applying a vacuum to the cartridge by a vacuum device, thereby removing at least a part of the residual material from the cartridge.

### CROSS-REFERENCE TO RELATED APPLICATION

This application is a U.S. national stage application of International Application No. PCT/EP2023/080555, filed on Nov. 2, 2023, which claims priority to GB Application No. 2219666.1, filed on Dec. 23, 2022, the contents of each of which are hereby incorporated by reference.

### BACKGROUND

### Technical Information

The disclosure relates to alternative methods of emptying a cartridge to be recycled, in particular a cartridge assembly, a method of emptying a dispenser tip to be recycled, and a method of refilling an at least partially spent cartridge. The disclosure further relates to a cartridge, a dispenser tip, a dispenser tip assembly comprising the dispenser tip, a hybrid piston, and a hybrid piston assembly comprising the hybrid piston.

### Background Information

In the industrial sector, in the construction industry, for example of buildings, and in the dental sector, cartridges are frequently used to store liquid flowable, frequently pasty or viscous to highly viscous substances and to dispense them for the respective application as required. Examples for such substances are joint sealing compounds, compounds for chemical dowels or chemical anchors, adhesives, pastes or impression materials in the dental sector.

A distinction is made between single-component systems in which the material to be dispensed is only made of one component and two-component or multicomponent systems (also referred to as “cartridge assembly”) in which at least two different components are stored in separate chambers of the same cartridge or in separate cartridges, wherein the components are intimately mixed on dispensing by a dynamic or static mixing apparatus. Examples for this are two-component adhesives or chemical dowels which only harden after the mixing of the two components. Two-component systems are in particular also used in the industrial sector for paints which are often used to generate functional protective layers such as for corrosion protection.

### SUMMARY

These cartridges are usually produced from plastic and are manufactured in an injection molding process. Cartridges filled with a material to be dispensed are usually designed for a one-way use. Due to the nature of most filling materials, in particular adhesives, the material will usually never be entirely dispensed from the cartridge and residues will be left over within the cartridge. This also applies for a dispenser tip attached to the cartridge, such that most filling materials will never be entirely dispensed from the tip. At present, it is therefore common practice to dispose of a cartridge and/or a dispenser tip used only once. This causes considerable waste associated with an increasing environmental burden.

Since cartridges and/or dispenser tips are mainly made of at least one kind of plastic, the majority of the waste is plastic-based. One way to accommodate the environmental damage of this waste is to recycle the plastic. At present, recycling of used cartridges and/or dispenser tips is highly challenging as the cartridges and/or the dispenser tips are contaminated with residual filling material. Most of these materials are at least irritant and typically hazardous. In order to comply with environmental regulations, a straight-forward preparation of used cartridges and/or dispenser tips for recycling is not possible so that these cartridges and/or tips must be discarded together with the residual material as hazardous waste.

In this context, it has been determined that there is a need for a method of emptying a cartridge for recycling purposes. There is a need for a method of emptying a cartridge assembly for recycling purposes. There is also a need for a method of emptying a dispenser tip attached to the cartridge for recycling purposes. There is also a need for a cartridge configured to remove residual material from the cartridge for recycling purposes. There is also a need for a method of reusing a cartridge. There is also a need for a reusable dispenser tip.

This need is satisfied by the subject matter disclosed herein. In particular, this need is satisfied by a method of emptying a cartridge to be recycled disclosed herein. This need is further satisfied by a method of emptying a dispenser tip to be recycled as disclosed herein. This need is further satisfied by a cartridge as disclosed herein. This need is further satisfied by a method of refilling an at least partially spent cartridge as disclosed herein. This need is further satisfied by a dispenser tip and a dispenser tip as disclosed herein. Exemplary embodiments are further discussed in the present disclosure.

According to a first aspect of the disclosure, a method of emptying a cartridge to be recycled, in particular a cartridge assembly, is provided, wherein the method comprises the steps of
i) a1) providing a cartridge filled with a volume amount of a residual material to be removed from the cartridge, the cartridge comprising a solid head part having an outlet part forming an outlet; and
ii) b1) applying a vacuum to the cartridge by a vacuum device, thereby removing at least a part of the residual material from the cartridge.

As used herein, a “solid head part of the cartridge”, “solid head part” or “head part” refers to a solid upper part of the cartridge which is typically mounted on at least one cartridge chamber where a filling material is stored. The head part is sealingly and typically non-releasably connected to the chamber. The head part is a part which sealingly and typically non-releasably covers a cross-sectional shape of an upper open end of the cartridge chamber.

As used herein, a “cartridge chamber” or “chamber” refers to a typically—but not necessarily—substantially cylindrical main body of a cartridge in which a filling material is stored.

In some embodiments, the cartridge chamber is flexible.

In a preferred embodiment, the cartridge chamber is solid, preferably formed from the same material as the solid head part. The cartridge chamber and the solid head part can be formed as one piece by way of injection molding process. In a preferred embodiment, the cartridge chamber is solid and rigid, i.e., not flexible. A cartridge comprising at least one rigid and thick-walled chamber is particularly preferred as such a cartridge is particularly profitable in terms of recycling aspects. As used herein, a thick-walled chamber is defined as a cartridge chamber having a wall thickness in the range of from 0.3 mm to 3 mm. Exemplary thicknesses are 0.75 mm, 1.5 mm, 2.1 mm and 2.3 mm. Each of these values is to be understood to cover tolerances of around 0.2 mm, 0.1 mm or 0.05 mm. Generally speaking, the wall thickness increases with the volume of the chamber.

As used herein, an “outlet of a cartridge” refers to a hollow channel formed by a so-called “outlet part” situated on top of a solid head part of the cartridge, the outlet being configured for a filling material to be dispensed from the cartridge chamber to the outside, preferably from a cartridge chamber to a dispenser tip attached to the outlet part of the cartridge.

In step a1) of the first aspect of the disclosure, a cartridge is provided which is filled with a volume amount of a residual material to be removed from the cartridge. The residual material usually remains at least in an outlet of the cartridge after having used the cartridge for its intended application.

In addition to the outlet, the residual material can also remain in the cartridge chamber after having used the cartridge for its intended application. This can be the case for when the intended application of the cartridge required less filling material than stored in the cartridge, or when the filling material is particularly viscous and/or adhesive.

As used herein, “emptying of a cartridge to be recycled” refers to at least partially emptying of the cartridge to be recycled. Similarly, “emptying of a dispenser tip to be recycled” refers to at least partially emptying of the dispenser tip to be recycled. In a preferred embodiment, a cartridge and/or a dispenser tip is emptied essentially completely. As used herein, “emptying essentially completely” of a cartridge and/or a dispenser tip refers to a degree of emptying the cartridge and/or the dispenser tip, which is sufficient for the entire cartridge and/or the entire dispenser tip to be subjected to the recycling stream.

It is to be understood that “emptying of a cartridge and/or a dispenser tip to be recycled” can also mean that at least one part of the cartridge and/or at least one part of the dispenser tip is no longer relevantly contaminated, so that the part can be subjected to the recycling stream. It is implied that emptying of a cartridge to be recycled and/or a dispenser tip to be recycled means a reduction of a volume amount of a residual material within the cartridge and/or the dispenser tip. Even if only a part of a residual material is removed from a dispenser tip and/or a cartridge, the emptied part can be subjected to recycling. The part, i.e., the part of the dispenser tip and/or the cartridge which is no longer contaminated (decontaminated), can be easily separated from the contaminated rest of the dispenser tip and/or cartridge, such as by way of cutting, sawing or lasering. The contaminated rest can be disposed as (non-) hazardous waste, whereas the decontaminated part of the dispenser tip can enter the recycling stream.

As used herein, the term “contaminated” refers to a cartridge and/or a dispenser tip, which contains a residual filling material, i.e., residual filling material, to be removed therefrom. The term is not limited to an irritant, toxic and/or hazardous residual material but can also be a non-irritant, non-toxic, and/or non-hazardous residual material. For example, a contaminated cartridge refers to a used cartridge which is at least partially filled with a residual material (irritant, toxic, hazardous, non-irritant, non-toxic, and/or non-hazardous), wherein the residual material is intended to at least partially be removed from the cartridge to be recycled. For example, a contaminated dispenser tip refers to a used dispenser tip which is at least partially filled with a residual material (irritant, toxic, hazardous, non-irritant, non-toxic, and/or non-hazardous), wherein the residual material is intended to at least partially be removed from the dispenser tip to be recycled.

The degree of emptying a cartridge and/or a dispenser tip, i.e., the degree of decontamination, can depend on the nature of the filling material. In some embodiments, a filling material, such as an adhesive, can be more difficult to essentially completely remove from the cartridge and/or the dispenser tip. In such cases emptying of the cartridge is preferably performed by applying a stronger vacuum in step b1), thereby sucking out the residual material by way of the stronger vacuum.

The pressure range required by the vacuum to at least partially remove, i.e., suck out, a residual material from a cartridge and/or a dispenser tip (herein also referred to as “sufficient vacuum”) can be a low vacuum, i.e., prevailing atmospheric pressure (31 kPa to 110 kPa) to 100 Pa, or a medium vacuum, i.e., <100 Pa to 0.1 Pa, as defined in ISO 3529-1:2019. A low vacuum is preferred.

Thus, the vacuum applied in step b1) is less than 100 Pa, in particular less than 75 Pa, preferably less than 50 Pa.

Any suitable vacuum device can be used for applying a vacuum in step b1) in the method of the first aspect of the disclosure, such as a positive displacement vacuum pump.

The method according to the first aspect of the disclosure preferably comprises a step c1) after step a1) and prior to step b1), wherein step c1) comprises connecting a vacuum device to the outlet part of the cartridge. This can be performed by using an adaptor connecting the vacuum device to the outlet part of the cartridge, wherein the adaptor, such as a tube, is capable of maintaining the chosen pressure range, i.e., the adaptor being suitable for vacuum applications.

During or after step b1), the volume amount of a residual material can be reduced within the cartridge by at least 10%, based on the total volume amount of the residual material present in the cartridge in step a1). More preferably, the volume amount of a residual material can be reduced within the cartridge by at least 15%, by at least 20%, by at least 25%, by at least 30%, by at least 40%, by at least 50%, by at least 60%, by at least 70%, by at least 80%, by at least 90%, or by at least 95%, based on the total volume amount of the residual material present in the cartridge in step a1).

In another embodiment, the residual material is removed from the cartridge via a dispenser tip attached to the outlet part of the cartridge. That is, the cartridge of the method according to the first aspect of the disclosure further comprises a dispenser tip which is sealingly and releasably connected to the cartridge, wherein the dispenser tip can also at least partially be emptied in addition to the cartridge.

In other words, a method of emptying a cartridge to be recycled and a dispenser tip to be recycled, in particular a cartridge assembly, is preferably provided, wherein the method comprises the steps of
i) a1-i) providing a cartridge comprising a dispenser tip attached to the outlet part of the cartridge, wherein the cartridge and the dispenser tip are filled with a volume amount of a residual material to be removed from the cartridge and the dispenser tip via the dispenser tip, the cartridge further comprising a solid head part having an outlet part forming an outlet; and
ii) b1-i) applying a vacuum to the cartridge comprising the dispenser tip by a vacuum device, thereby removing at least a part of the residual material from the cartridge and at least a part of the residual material from the dispenser tip.

In this context, the expression “sealingly and releasably connected” means that there will be no relevant leakage of the cartridge contents during storage or use and that the cartridge will not detach from the dispenser tip during normal storage and/or use conditions but will detach from the dispenser tip when intended to do so, such as by unscrewing a thread part of the dispenser tip, thereby disconnecting the dispenser tip from the cartridge.

The method according to the first aspect of the disclosure preferably comprises a step c1) after step a1) and prior to step b1), wherein step c1) comprises connecting a vacuum device to an outlet of a dispenser tip attached to the outlet part of the cartridge. This can be performed by using an adaptor connecting the vacuum device to the outlet of the dispenser, wherein the adaptor, such as a tube, is capable of maintaining the chosen pressure range, i.e., the adaptor being suitable for vacuum applications.

At least partially removing a residual material from not only the cartridge but also from the dispenser tip is particularly beneficial in terms of recycling. In particular, a vacuum is applied to the cartridge via a dispenser connected to the cartridge until the cartridge is essentially completely emptied and the dispenser tip is at least partially, preferably essentially completely emptied.

It is understood that when a sufficient vacuum is applied to the cartridge via a dispenser connected to the cartridge, the vacuum initially allows the cartridge to at least partially be emptied before at least partially emptying the attached dispenser tip.

In a second aspect of the disclosure, a method of emptying a cartridge to be recycled, in particular a cartridge assembly, is provided, wherein the method comprises the steps of
i) a2) providing a cartridge filled with a volume amount of a residual material to be removed from the cartridge, the cartridge comprising a solid head part having an outlet part forming an outlet, a lower part opposite to the head part with regard to a longitudinal direction (A) of the cartridge, and a piston moveable through the cartridge, the piston having at least one ventilating opening extending between a surface facing the head part and a surface facing the lower part; and
ii) b2) applying a pressurized fluid through the at least one ventilating opening by a pressurized fluid device, thereby urging and removing the residual material from the cartridge.

As used herein, the term “lower part” of a cartridge is the part being situated opposite to the head part with regard to a longitudinal direction (A) of the cartridge. The longitudinal direction (A) is also shown in FIG. 1.

In step a2) of the second aspect of the disclosure, a cartridge is provided which is filled with a volume amount of a residual material to be removed from the cartridge. The residual material usually remains at least in an outlet of the cartridge after having used the cartridge for its intended application, or in a cartridge chamber, as described above with regard to the first aspect of the disclosure.

As used herein, the term “ventilating opening” or “ventilation opening” refers to an opening extending through the piston, such as a ventilation channel. In more detail, an opening is provided between a surface of the piston which faces the head part of the cartridge and a surface of the piston which faces the lower part of the cartridge. Due to the opening, it is possible for a fluid to flow through the piston.

As used herein, a “pressurized fluid” means any fluid capable of flowing through the piston and forcing, i.e., urging, at least one part of a residual material out of a cartridge, or out of a cartridge and a dispenser tip attached to the cartridge. For example, the pressurized fluid, such as pressurized gas and/or liquid, can be compressed air, pressurized water, or any applicable pressurized solvent. The pressurized fluid can be capable of urging at least one part of the residual material out based on the pressure of the fluid (herein also referred to as “mechanically urging out of the residual material”, “mechanical urging” or “mechanical pressurizing”). As an alternative or in addition thereto, the pressurized fluid can be capable of dissolving at least one part of the residual material, thereby urging out at least one part of the material (herein also referred to as “chemically urging out of the residual material”, “chemical urging” or “chemical pressurizing”).

In a preferred embodiment, the pressurized fluid is compressed air. In another preferred embodiment, the pressurized fluid is a pressurized solvent, the solvent being chosen as one in which a residual material in a cartridge is at least partially soluble. In another preferred embodiment, the pressurized fluid is a pressurized solvent, the solvent being chosen as one in which the residual material in the cartridge and the residual material in the dispenser tip is at least partially soluble.

The pressurized fluid can preferably have a pressure of at least 0.5 bar or 1 bar, and preferably of less than 20 bar. In a preferred embodiment, the pressurized fluid has a pressure ranging of from 3 bar to 15 bar. In another preferred embodiment, the pressurized fluid has a pressure ranging of from 4.5 bar to 12 bar. In another preferred embodiment, the pressurized fluid has a pressure ranging of from 5 bar to 10 bar. In another preferred embodiment, the pressurized fluid has a pressure ranging of from 6 bar to 8 bar.

The pressure of the pressurized fluid required to urge out at least one part of a residual material from the cartridge and optionally from the dispenser tip can depend on the nature of the residual material, the choice of the pressurized fluid and therefore the type of urging of the residual material (mechanically/pressure-based or mechanically and chemically), the geometry of the ventilating opening, the number of the ventilating openings in the piston, the size of the piston, and the like.

Any suitable pressurized fluid device can be used for applying a pressurized fluid in step b2) in the method of the second aspect of the disclosure.

In step b2), it is preferred that the ventilation opening has a form which allows the pressurized fluid to efficiently flow through the piston. For example, the ventilation opening can preferably be a linear channel. That way, the length of the ventilating opening can preferably be equal to the height of the piston in a longitudinal direction (A) of the cartridge, wherein the height of the piston extends between the surface of the piston which faces the head part of the cartridge and the surface of the piston which faces the lower part of the cartridge.

The ventilation opening is preferably a ventilation opening typically used during a filling step of a cartridge.

In a preferred embodiment, the residual material is removed from the cartridge via a dispenser tip attached to the outlet part of the cartridge. That is, the cartridge of the method according to the second aspect of the disclosure further comprises a dispenser tip which is sealingly and releasably connected to the cartridge, wherein the dispenser tip can also at least partially be emptied in addition to the cartridge.

At least partially removing a residual material from not only the cartridge but also from the dispenser tip is particularly beneficial in terms of recycling.

It is understood that when a sufficient amount of pressurized fluid and/or a sufficiently pressurized fluid is applied to the cartridge via a dispenser connected to the cartridge, the pressurized fluid initially allows the cartridge to at least partially be emptied before at least partially emptying the attached dispenser tip.

In another embodiment, a pressurized fluid is applied to at least one ventilation opening until the cartridge is essentially completely emptied and the dispenser tip is at least partially emptied. In an even more preferred embodiment, a pressurized fluid is applied to at least one ventilation opening until both the cartridge and the dispenser tip are essentially completely emptied.

In another preferred embodiment, the method according to the second aspect of the disclosure further comprises a step c2) after step a2) and prior to step b2), wherein step c2) comprises connecting a pressurized fluid device to the ventilating opening of the piston. This can be performed by using an adaptor connecting the pressurized fluid device to at least one ventilating opening, wherein the adaptor, such as a tube, is capable of maintaining the chosen pressure range, i.e., the adaptor being suitable for pressurized applications.

The method according to the second aspect of the disclosure can be considered as an alternative to the method according to the first aspect of the disclosure.

However, in a third aspect of the disclosure, a method of emptying a cartridge to be recycled and optionally a dispenser tip to be recycled is provided, wherein the method comprises the steps of the method according to the second aspect of the disclosure in addition to the steps of the method according to the first aspect. In doing so, the degree of emptying a cartridge to be recycled and optionally a dispenser to be recycled can efficiently be enhanced.

In a fourth aspect of the disclosure, a method of emptying a dispenser tip to be recycled, is provided, wherein the method comprises the steps of
i) a3) providing a dispenser tip attached to an outlet part of a cartridge, the dispenser tip being filled with a volume amount of a residual material to be removed from the dispenser tip, the cartridge further comprising a solid head part having an outlet part forming an outlet and a lower part opposite to the head part with regard to a longitudinal direction (A) of the cartridge, the cartridge further comprising a piston moveable through the cartridge;
ii) b3-1) pulling the piston towards the lower part of the cartridge, thereby re-moving the residual material from the dispenser tip into the cartridge; and/or
iii) b3-2) connecting an outlet of the dispenser tip to a pressurized fluid device, and applying a pressurized fluid by the pressurized fluid device through the dispenser tip, such as pressurized gas and/or liquid, thereby urging the residual material from the dispenser tip into the cartridge.

In step a3) of the fourth aspect of the disclosure, not only the dispenser tip but also the cartridge attached thereto can be filled with a residual amount of filling material. However, the method according to the fourth aspect of the disclosure is directed to at least partially emptying the dispenser tip. This is because the residual material in the dispenser tip is pressed, i.e., urged, into the cartridge by a step b3-1) and/or step b3-2).

The fourth aspect of the disclosure is preferably used in such cases where it is more beneficial to recycle the dispenser tip, for example when the cartridge has a thin-walled chamber, such as a film chamber, or generally when the dispenser tip is formed from a higher plastic amount than the cartridge. In such cases, it would be more environmentally friendly to rather recycle a dispenser tip representing more plastic waste to be recycled than the cartridge. However, the application of the method according to the fourth aspect is not limited thereto.

The method according to the fourth aspect of the disclosure provides an at least partially emptied dispenser tip, as already aforementioned with regard to the first, second and third aspects of the disclosure. It is preferred that the dispenser tip is emptied essentially completely. That way, the emptied dispenser tip as a whole can be recycled. However, even if only a part of the residual amount is removed from the dispenser tip, the part can be subjected to recycling. The part, i.e., the part of the dispenser tip which is decontaminated, can be separated from the contaminated rest of the dispenser tip, such as by way of cutting, sawing or lasering. The contaminated rest can be disposed as (non-) hazardous waste, whereas the decontaminated part of the dispenser tip can enter the recycling stream.

Step b3-1) is an easily implementable way to at least partially empty a dispenser tip comprising a volume amount of a residual material, wherein the way only requires puling a piston inside a cartridge chamber towards the lower part of the cartridge. This can be performed by hand or automatically. It is preferable that in step b3-1), the piston is non-permeable to air in order to create a sufficient vacuum in the cartridge which is able to suck at least one part of a residual material from within the dispenser tip into the cartridge. Step b3-1) can be used in cases where the residual material in the dispenser tip has a low viscosity and/or in cases where the cartridge has a single chamber. In case of a cartridge assembly, the at least one piston can be pulled simultaneously in order to create a sufficient vacuum in the cartridge assembly.

In alternative or additional step b3-2), an outlet of the dispenser tip is connected to a pressurized fluid device in order to allow a pressurized fluid to flow through the dispenser tip. The pressurized fluid and the pressurized fluid device already mentioned with regard to the methods according to the second and third aspects of the disclosure, can also apply for the method according to the fourth aspect. It is understood that step b3-2) can be more forceful and is particularly preferred over step b3-1) or provided in addition in cases where the residual material in the dispenser tip has a high viscosity and/or in cases where the cartridge has at least two chambers.

A further advantageous effect of the method according to the fourth aspect of the disclosure, is that when it is applied using a cartridge assembly, the cartridge assembly can at least be disposed as non-hazardous waste. That is, a cartridge assembly comprising for example two chambers or two cartridges each one of which is filled with a different material which cure after a predetermined time upon mixing, in particular upon mixing in air. Sucking of the mixed material from the dispenser tip into each one of the cartridge chambers or cartridges therefore enables the non-mixed material in each one of the chambers or cartridges to cure. This effect can be enhanced with an increasing amount of the mixed material inside the dispenser tip being sucked into each one of the cartridge chambers or cartridges.

In a preferred embodiment, the cartridge comprises a volume amount of the residual material of from about 1% to about 50%, based on a total volume of the cartridge, preferably of from about 3% to about 40%, of from about 5% to about 30%, of from about 10% to about 20%, or of from 13% to about 17%, based on a total volume of the cartridge. The volume amount of the residual material is referred to a volume amount of a residual material to be removed from a used cartridge. In other words, in steps a1), a1-i), a2) and/or a2-i) of the herein described methods, a used cartridge is provided which is filled with a volume amount of a residual material of from about 1% to about 50%, based on a total volume of the cartridge, preferably of from about 3% to about 40%, of from about 5% to about 30%, of from about 10% to about 20%, or of from 13% to about 17%, based on a total volume of the cartridge.

In another preferred embodiment, the dispenser tip comprises a volume amount of the residual material of from about 60% to about 100%, based on a total volume of the dispenser tip, preferably of from about 70% to about 95%, of from about 80% to about 90%, or of from about 83% to about 87%, based on a total volume of the dispenser tip. The volume amount of the residual material is referred to a volume amount of a residual material to be removed from a used dispenser tip. In other words, in steps a1-i), a2-i) and/or a3) of the herein described methods, a used dispenser tip is provided which is filled with a volume amount of a residual material of from about 1% to about 50%, based on a total volume of the dispenser tip, preferably of from about 3% to about 40%, of from about 5% to about 30%, of from about 10% to about 20%, or of from 13% to about 17%, based on a total volume of the dispenser tip.

In another preferred embodiment, the cartridge comprises a volume amount of the residual material of from about 1% to about 50%, based on a total volume of the cartridge, preferably of from about 3% to about 40%, of from about 5% to about 30%, of from about 10% to about 20%, or of from 13% to about 17%, based on a total volume of the cartridge, and the dispenser tip comprises a volume amount of the residual material of from about 60% to about 100%, based on a total volume of the dispenser tip, preferably of from about 70% to about 95%, of from about 80% to about 90%, or of from about 83% to about 87%, based on a total volume of the dispenser tip.

In another preferred embodiment, the dispenser tip comprises a mixer. This is particularly the case for when a cartridge assembly is used. The mixer can be configured to mix at least two materials from the at least two cartridge chambers. Many kinds of static or dynamic mixers are known and are thus not described here in detail.

In a fifth aspect of the disclosure, a cartridge, in particular a cartridge assembly, is provided, wherein the cartridge comprises a solid head part having an outlet part forming an outlet and a lower part opposite to the head part with regard to a longitudinal direction (A) of the cartridge, the cartridge further comprising a piston moveable through the cartridge in the longitudinal direction, the piston having a surface facing the head part and a surface facing the lower part, the piston comprising a protrusion extending from the surface facing the head part, the protrusion being aligned with the outlet and having a cross-sectional shape matching that of the outlet so that it is insertable into the outlet by a movement of the piston to remove residual material from the outlet part of the cartridge.

The cross-sectional shape is preferably circular. Other geometries are conceivable (e.g. rectangular, polygonal, oval, and the like).

The protrusion extends from the surface facing the head part of the cartridge, i.e., is situated on top of the piston surface facing the head part of the cartridge. For example, the protrusion can be some kind of a pin attached to or formed in the piston surface facing the head part of the cartridge.

Furthermore, the protrusion is aligned with the outlet of the cartridge which is important in order for the protrusion being moved towards the outlet when pressing the piston. That way the piston can press at least one part of the residual material out of the cartridge, in particular the cartridge chamber.

Furthermore, the protrusion has a cross-sectional shape matching that of the outlet of the cartridge which is essential in order for the protrusion to fit through the outlet of the cartridge. On the one hand, the protrusion should not have a cross-sectional shape greater than the cross-sectional shape of the outlet in order to fit in the outlet. On the other hand, the protrusion should not have a cross-sectional shape much smaller than the cross-sectional shape of the outlet in order to push as much residual material as possible out of the outlet. The cross-sectional shape of the protrusion is therefore preferably slightly smaller than the cross-sectional shape of the outlet of the cartridge in order to fulfill both aspects: fitting in the outlet and providing a sufficient surface in order to urge as much residual material as possible out of the cartridge chamber.

In case of a cartridge assembly, each one of the pistons has preferably a protrusion complementary to the respective outlet.

In a preferred embodiment, the protrusion has an extension in the longitudinal direction (A) at least equal to the extension of the outlet of the cartridge. In other words, the extension, i.e., height, of the protrusion is configured to reach through the complete extension, i.e., height, of the outlet of the cartridge. That way, not only the cartridge chamber but also the outlet of the cartridge can be sufficiently emptied. In another preferred embodiment, the protrusion has an extension in the longitudinal direction (A) which is greater than the extension of the outlet of the cartridge.

In a sixth aspect of the disclosure, a method of refilling an at least partially spent cartridge, in particular a cartridge assembly, is provided, wherein the method comprises the steps of
i) a4) providing an at least partially spent cartridge comprising a predetermined volume amount of a residual material, a solid head part having an outlet part forming an outlet and a lower part opposite to the head part with regard to a longitudinal direction (A) of the cartridge, the cartridge further comprising a piston moveable through the cartridge in the longitudinal direction, the piston having a surface facing the head part and a surface facing the lower part;
ii) b4) connecting the outlet part to a refilling system comprising a refill material; and
iii) c4) pulling the piston towards the lower part, thereby sucking the refill material so as to provide a refilled cartridge; and/or urging the piston towards the lower part by pressing the refill material into the cartridge so as to provide a refilled cartridge.

The method according to the sixth aspect of the disclosure is particularly beneficial for reusing fully functioning cartridges which otherwise would need to be disposed after a single use. This method allows a cartridge to be refilled and reused at least two times, preferably at least 5 times, more preferably at least 10 times

In step b4) of the method, the at least partially spent cartridge can be easily connected to a refilling system comprising a refill material, such as a barrel with a docking station. Refilling a cartridge according to the method is therefore particularly advantageous for applications on construction site where at least one docking stations for refilling can be established in order to attach and refill the partially spent cartridge without further effort.

It is essential in step a4) that the partially spent cartridge comprises a predetermined volume amount of a residual material. This is because the predetermined volume amount of a residual material allows an air free refilling process, i.e., the filling and/or the refilling material within the cartridge comprises no or a neglectable amount of air, such as in air bubbles. As used herein, a “filling material” is the material which is filled into a cartridge for a first time's use thereof. As used herein, a “refilling material” is the material stored in which is filled into a cartridge for an at least second times'use thereof.

In a preferred embodiment, the predetermined volume amount of a residual material in the at least partially spent cartridge is in the range of from about 30% to about 1%, of from about 20% to about 3%, of from about 10% to about 5%, based on a total volume of the at least partially spent cartridge.

In a preferred embodiment, the partially spent cartridge is provided with at least a predetermined volume amount of a material in the cartridge by limiting the movement of the piston towards the head part in a stop position during the process of dispensing the cartridge. The stop position is preferably a position of the piston in the cartridge at which the predetermined volume amount of a residual material in the cartridge lies in the range of from about 30% to about 1%, of from about 20% to about 3%, of from about 10% to about 5%, based on a total volume of the cartridge.

For example, in cases where the filling material is at least partially visible through the cartridge chamber, the stop position can be chosen with bare eye. In such cases, the movement of the piston towards the head part of the cartridge can be stopped when reaching the stop position.

In another preferred embodiment, the movement of the piston is limited in the stop position by providing a dispenser receiving the cartridge, wherein the dispenser comprises at least one movable plunger cooperating with the piston to move it in the longitudinal direction (A), wherein the plunger or a device driving the plunger is designed such that the piston is not movable beyond the stop position.

The design of the plunger is preferably such that a rod of the plunger has a length smaller than the length of the cartridge chamber in the longitudinal direction (A). That way, the plunger can not fully be pressed towards the head part of the cartridge but is stopped before reaching the head part.

In another preferred embodiment, the stop position is defined by providing the following. The head part preferably comprises at least one protrusion extending towards the piston, wherein the extension of the at least one protrusion in the longitudinal direction (A) defines the stop position. Alternatively, or in addition thereto, the piston preferably comprises at least one protrusion extending towards the head part of the cartridge, wherein the extension of the at least one protrusion in the longitudinal direction (A) defines the stop position.

The stop position is reached, when the protrusion on the head part or on the piston contacts the corresponding piston or head part, respectively, thereby limiting a further axial movement of the piston.

If a cartridge assembly is applied, a dispenser can be used which comprises as many movable plungers as the number of pistons in the cartridge assembly. For example, a cartridge assembly having two cartridge chambers, and therefore two pistons, also preferably has two movable plungers; each one of which is cooperating with each one of the two pistons in order to move each piston in the longitudinal direction (A) of the cartridge, i.e., in order to move the piston towards the head part and/or the lower part of the cartridge.

The plunger is preferably releasably or non-releasably connected to the piston such that pulling the plunger towards a lower part of the cartridge simultaneously results in pulling the piston towards the lower part of the cartridge. In this context, “non-releasably connected” means that the plunger will not detach from the piston during normal storage and use conditions.

In a seventh aspect of the disclosure, a dispenser tip comprising a mixer and a mixer sheath is provided, wherein the mixer comprises a first end and a second end opposite to the first end with regard to a longitudinal axis (B) of the dispenser tip, the second end of the mixer, wherein the mixer sheath covers the mixer in a circumferential direction and is formed by a flexible or thin-walled rigid material.

In a preferred embodiment, the material of the mixer sheath, if flexible, is selected from the group consisting of a paper and/or a polymer film. For example, the polymer film can be a laminated film. Alternatively, the mixer sheath can be thin-walled and rigid. In both cases, the amount of waste associated with the disposal of a singly used dispenser tip can be more efficiently reduced. In a preferred embodiment, the wall-thickness of the mixer sheath is 500 μm or less and 1 μm or more, preferably 300 μm or less and 5 μm or more, more preferably 100 μm or less and 10 μm or more, even more preferably 70 μm or less and 30 μm or more. Generally speaking, a suitable flexible material has typically a thickness of 70 μm to 150 μm, whereas a thin-walled rigid sheath can have a thickness of 300 μm to 500 μm. The rigid sheath can be formed in one piece with at least one of the components of the tip, in particular in one piece with the mixer.

In order to increase the mechanic stability of the mixer sheath while limiting the wall thickness thereof for environmental reasons (in particular waste reduction), it is preferred that the mixer sheath (in particular if flexible) comprises at least two layers, preferably an inner and an outer layer. The inner layer can face the mixer, while the outer layer can not face the mixer, i.e. the outer layer is situated on top of the inner layer. In a preferred embodiment, the inner layer is made of a polymer film, and the outer layer is made of paper. That way, it can be avoided that a viscous filling material or an adhesive filling material sticks against the polymer film-based mixer sheath, while providing a certain degree of mechanical stability for an environmentally friendly dispenser tip.

In another preferred embodiment, the tip further comprises a connecting part being non-releasably or releasably connected to the mixer, the connecting part being configured and adapted to be connected to an outlet part of a cartridge.

In this context, “releasably connected” to the mixer means that the connecting part will not detach from the mixer during normal storage and/or use conditions but will detach from the mixer when intended to do so, such as by unscrewing the connecting part from the dispenser tip, thereby disconnecting the dispenser tip from the mixer.

In this context, “non-releasably connected” to the mixer means that the connecting part will not detach from the mixer during normal storage and/or use conditions. Also, the connecting part will not detach from the mixer when intended to do so, such as by unscrewing or clip unlocking. The connecting part and the mixer can be a unitary element, formed e.g. by injection molding.

The connection part connects the dispenser tip to the mixer and is configured and adapted to be connected to an outlet part of a cartridge. For example, the connecting part can be a thread part connecting the dispenser tip to the cartridge by screwing the connecting part onto the outlet part. It is understood that in this example, the outlet part of the cartridge would have a suitable screwing counterpart.

Alternatively, the connecting part can be a part of a clip lock connecting the dispenser tip to the cartridge by clipping the connecting part onto the outlet part. It is understood that in this example, the outlet part of the cartridge would have a suitable clip lock counterpart. A plug connection is also conceivable. The different types of connection can be combined

In another preferred embodiment, the sheath is connected, in particular non-releasably connected to the connecting part.

In this context, “non-releasably connected” to the connecting part means that the sheath will not detach from the connecting part during normal storage and/or use conditions. Also, the sheath will not detach from the connecting part when intended to do so, such as by unscrewing or clip unlocking.

In another preferred embodiment, the connecting part comprises at least two separate channels, each having an inlet opening associated with one of a first outlet opening or a second outlet opening of the outlet part of the cartridge and having an outlet opening associated with the mixer.

In an eighth aspect of the disclosure, a dispenser tip assembly is provided, wherein the dispenser tip assembly comprises a rigid support sleeve comprising a first end and a second end opposite to the first end with regard to a longitudinal axis (B) of the dispenser tip, wherein the support sleeve is configured to receive at least the part of the dispenser tip according to the seventh aspect of the disclosure comprising the mixer.

The rigid support sleeve is characterized in that it is not flexible, unlike the mixer sheath which can be flexible and not rigid. This difference can be influenced by varying the wall-thicknesses thereof. In a preferred embodiment, the wall thickness of the mixer sheath is smaller than the wall thickness of the support sleeve. In a preferred embodiment, the wall-thickness of the support sleeve is 1000 μm or less and 100 μm or more, preferably 800 μm or less and 200 μm or more, more preferably 600 μm or less and 300 μm or more, even more preferably 500 μm or less and 400 μm or more.

The rigid support sleeve provides for a sufficient mechanical stability for the dispenser tip (that the flexible or thin-walled rigid sheath does not provide) in order to use the dispenser tip assembly for its intended application.

The dispenser tip according to the eighth aspect of the disclosure is particularly advantageous for multiple reusing of the support sleeve by successively receiving a dispenser tip comprising a mixer and a mixer sheath. That way, the contact area of the material to be dispensed, such as a viscous material or an adhesive, is limited to the mixer sheath, preferably to the inner layer of the mixer sheath, thereby sparing the support sleeve from being contaminated. This is particularly beneficial from an environmental point of view, in particular in view thereof that the support sleeve preferably has a wall-thickness that is greater than that of the mixer sheath. As the sleeve preferably does not come in contact with the material(s) contained in the cartridge (assembly) it can be reused without the necessity to clean it.

In a preferred embodiment, the wall thickness of the mixer sheath is 30% smaller than the wall thickness of the support sleeve, more preferably 50% smaller, even more preferably 60% smaller, still more preferably 80% smaller than the wall thickness of the support sleeve.

In another preferred embodiment, the support sleeve is releasably or non-releasably connected to the connecting part.

In this context, “releasably connected” to the connecting part means that the support sleeve will not detach from the connecting part during normal storage and/or use conditions but will detach from the connecting part when intended to do so, such as by unscrewing the support sleeve from the connecting part, or by clip unlocking.

In this context, “non-releasably connected” to the connecting part means that the support sleeve will not detach from the connecting part during normal storage and/or use conditions. Also, the support sleeve will not detach from the connecting part when intended to do so, such as by unscrewing or clip unlocking.

In another preferred embodiment, at least one portion of the sheath is disposed, in particular clamped between the support sleeve and the connecting part. That is, at least one portion of the sheath is not covered by the support sleeve. The portion is preferably situated at the first end and/or the second end of the mixer with regard to the longitudinal axis (B). In particular, the portion of the sheath at the second end of the mixer is clamped between the support sleeve and the connecting part. That way, the mixer sheath can conveniently be fixed to the dispenser tip assembly without needing any additional fixing element.

In another preferred embodiment, the support sleeve is provided with at least one stop element cooperating with the mixer and/or with the connecting part so as to limit a relative axial movement of the mixer and/or of the connecting part during use of the tip assembly.

In another preferred embodiment, the first end of the mixer sheath extends radially inwardly from the longitudinal axis (B). In doing so, a smaller outlet of the mixer sheath is provided so that the material inside the mixer sheath can be dispensed more precisely.

In a more preferred embodiment, the first end of the mixer sheath and of the first end of the support sleeve extend radially inwardly from the longitudinal axis (B).

In a ninth aspect of the disclosure, a hybrid piston is comprising a hollow rigid ring part defining a side wall of the piston that is adapted to cooperate with an inner sidewall of a cartridge, and a head part defining a top surface of the piston, the head part being disposed on the ring part, wherein the ring part and the head part are sealingly and releasably or fixedly connected to one another, in particular wherein the head part is at least partially made of a flexible material.

In use, the top surface of the head part faces and is in contact the material disposed in the cartridge.

The head part can be rigid or flexible. It is also conceivable that it is in sections flexible and in sections rigid.

The head part can form a cap covering the side of the ring part that faces the interior of the cartridge.

The ring part of the hybrid piston can form a hollow body which can resemble at least substantially a hollow cylinder (with not necessarily circular cross-section) with at least one open end (lower end). The open lower end can be adapted to receive a plunger intended to move the piston in the cartridge.

The head part of the hybrid piston covers an upper end of the ring part, thereby forming a top surface of the piston. The ring part can have a closed upper end face that is in contact with the head part. However, the upper end of the ring part can be provided with an aperture that is covered by the head part.

The ring part and the head part are sealingly connected to one another, meaning that when the hybrid piston is used in a cartridge, i.e., the hybrid piston being arranged inside a cartridge chamber in a moveable manner along a longitudinal direction (A) of the cartridge, no filling material gets from the cartridge chamber inside the hollow piston. The decontamination of the inner side of the hybrid piston is prevented by the head part forming a top surface of the piston, wherein the head part is sealingly connected to the rigid part.

According to one variant of this aspect that the ring part and the head part are releasably connected to one another. As used herein, this means that the head part and the rigid part can be detached from one another when intended to do so, such as by pulling off the head part from the ring part. Under normal use and storage conditions, however, the ring part does not detach or is not released from the head part.

The head part and the ring part can be sealingly and releasably connected by any appropriate adhesive, such as adhesive tape and/or glue, or any appropriate fastener, such as a fastening clamp and/or a fastening ring. A welded connection that allows to rip or tear the head part off the ring part is also conceivable.

The hybrid piston is used together with any kind of cartridge, such as a cartridge assembly, as described herein. It is used analogously to a “normal” piston not having the herein claimed features, in particular not having a combination of a ring part and a head part as defined herein.

By using the hybrid piston in a cartridge, it is achieved that only the head part thereof is in direct contact to a filling material inside a cartridge (chamber). By avoiding a direct contact between the filling material and the ring part, the ring part is not contaminated, i.e., does not get dirty. In doing so, it is avoided that the rigid part needs to be cleaned, and more importantly disposed after usage, in particular after a single use, which is typical for a common (not-hybrid) piston. This is particularly the case for when a filling material rapidly cures so that a sufficient cleaning of a common piston is elaborate and/or inefficient after intended usage in a cartridge.

In other words: The ring part provides the mechanical stability of the hybrid piston and the head part protects it from the material in the cartridge. Thus, the head part acts like a protective sleeve.

The hybrid piston is advantageous form an environmental point of view because at least the ring part can be used multiple times. As indicated above, the herein claimed hybrid piston does not need to be disposed of after a single use. Instead, after usage of the hybrid piston in a cartridge, the contaminated head part thereof is released from the substantially not decontaminated ring part, such as by pulling or tearing it off. In a second using step, the same (not decontaminated) ring part can be used in combination with a new or cleaned head part.

However, according to another variant of this aspect of the disclosure the head part can also be fixedly connected to the ring part. In this case, it is not intended to be removed prior to disposal of the hybrid piston.

An outer surface section of the ring part can be connected to an inner surface section of the head part. The higher the contact area between the outer surface of the ring part and the inner surface of the head part, the stronger is the connection between those two components. A section of the head part can have an axial extension so as to cover a section of an outer sidewall of the ring part.

The wall thickness of the head part can smaller than the wall thickness of the ring part and/or wherein the ring part is made of a more stable or rigid material than the head part. Thereby, the amount of material needed to form the piston is reduced

A ratio of the wall thickness of the head part to the wall thickness of the rigid part can be 0.5 or less, 0.4 or less, 0.3 or less, 0.2 or less or even 0.1 or less. However, the ration can even be lower. Generally speaking, the ring part can typically have a wall thickness of 500 μm to 1 mm, 2 mm or even 3 mm, whereas the head portion can typically have a wall thickness of 50 μm to 500 μm, in particular in case it is flexible. A rigid head portion can have a greater thickness.

In other words, the above-mentioned ratio is 0.5 or much less. This is particularly the case for when the head part is any common flexible polymer film which can withstand a movement of the hybrid piston towards a filling material inside a cartridge (chamber) in order to dispense the filling material out of the cartridge. For example, the flexible part can be a piece of a plastic wrap.

More importantly, the hybrid piston is advantageous from an environmental point of view because of the possibility of the flexible part to stretch and thereby adapt to any shape of a plunger movable though the hollow hybrid piston. This aspect is described in more detail further below.

In a tenth aspect of the disclosure, a piston assembly is provided comprising a plunger that can be positioned in the hollow ring part of the hybrid piston according to the ninth aspect, wherein the plunger comprises a leading surface that can be brought into contact with a surface of the head part, the leading surface having a non-flat geometry. The leading surface can be convex. The leading surface can be configured to deform the head part of the hybrid piston elastically or plastically during use of the hybrid piston assembly.

The hybrid piston assembly is used together with any kind of cartridge, such as a cartridge assembly, as described herein.

In addition to the advantages described with respect to the hybrid piston, the tenth aspect of the disclosure is also beneficial for an efficient emptying of a cartridge, thereby making the cartridge reusable. This is because the leading surface can preferably be configured to stretch the head part of the hybrid piston defining the top surface of the piston along the longitudinal direction (C). As a result, the leading surface being covered with the stretched head part of the hybrid piston can extend beyond the ring part of the piston and towards the inside of the cartridge (chamber), thereby urging a higher amount of the filling material out of the cartridge (chamber). An inner geometry of the head part of a cartridge can have a geometry complementary to that of the leading surface.

It should be noted in this context that the concept of providing a non-flat design of the inner geometry of the head part of a cartridge (e.g. dome-like design) and a matching convex design of a leading surface of the piston can also be applied to conventional cartridge-piston assemblies.

In an eleventh aspect of the disclosure that can be combined with the other aspects of the disclosure, a cartridge is provided, in particular a cartridge assembly, comprising at least one chamber having a head part, in particular solid had part, having an outlet part forming an outlet and a lower part opposite to the head part with regard to a longitudinal direction (A) of the cartridge, the cartridge further comprising
i) a piston moveable through the cartridge in the longitudinal direction, the piston comprising at least one sealed cavity containing a viscous or fluid material (or a mixture of materials), such as a reactant and/or a rinsing fluid and/or a solvent, and
ii) an unsealing means or device configured to open the cavity such that material of the cavity can flow into the chamber and vice versa.

The unsealing means can be at least one pointed or knife-like element (or a multitude of such elements) that is disposed on the head part and that extends into the chamber. Once the chamber is (nearly) emptied, the piston comes in contact with the at least one element that ruptures a wall of the sealed cavity facing the chamber allowing the material disposed in the cavity to enter the chamber (or vice versa).

The material can be a rinsing fluid and/or a solvent that supports the process of removing the residual material contained in the chamber of the cartridge. It is also conceivable that the material in the cavity helps to cure the residual material, so that the disposal of the emptied cartridge is less problematic.

The unsealing means can also be a kind of a valve activated passively (e.g. by a movement of the piston) or actively (e.g. by the user by pressing a specific section of the cartridge). The means can comprise flow directing elements to enhance the flow of material into and/or out of the cavity and/or to facilitate the mixture of the materials in the chamber and in the cavity.

The aspects of the disclosure described above and the features of their embodiments can freely be combined in order to obtain the desired effect.

### BRIEF DESCRIPTION OF THE DRAWINGS

The disclosure is further described with the following embodiments which are presented in the Figures. The Figures show:

FIG. 1 is an example of a cartridge known in the art;

FIG. 2 is a piston in more detail;

FIG. 3 is a schematic illustration of an embodiment of the method according to the first aspect of the disclosure for emptying a cartridge;

FIG. 4 is a schematic illustration of an embodiment of the method according to the first aspect of the disclosure for emptying a cartridge and dispenser tip;

FIG. 5 is a schematic illustration of an embodiment of the method according to the second aspect of the disclosure for emptying a cartridge;

FIG. 6A is a schematic illustration of an embodiment of the method according to the second aspect of the disclosure for emptying a cartridge and dispenser tip;

FIG. 6B is a schematic illustration of an embodiment of a cartridge with a piston having a sealed cavity filled with a viscous or fluid material;

FIG. 7 is a schematic illustration of an embodiment of the method according to the fourth aspect of the disclosure for a dispenser tip;

FIG. 8 is a schematic illustration of an alternative embodiment of the method according to the fourth aspect of the disclosure for a dispenser tip;

FIG. 9 is a schematic illustration of an embodiment of the cartridge according to the fifth aspect of the disclosure;

FIG. 10 is a schematic illustration of an embodiment of the method according to the sixth aspect of the disclosure for providing a refilled cartridge;

FIG. 11 is a schematic illustration of a stopping position in an embodiment of the method according to the sixth aspect of the disclosure for providing a refilled cartridge;

FIG. 12 is a schematic illustration of stopping elements in an embodiment of the method according to the sixth aspect of the disclosure for providing a refilled cartridge;

FIG. 13 is a schematic illustration of an embodiment of a dispenser tip according to the seventh aspect of the disclosure;

FIG. 14 is a schematic illustration of an embodiment of a dispenser tip assembly according to the eighth aspect of the disclosure;

FIG. 15 is a schematic illustration of an embodiment of a hybrid piston according to the ninth aspect of the disclosure; and

FIG. 16 is a schematic illustration of an embodiment of a hybrid piston assembly according to the tenth aspect of the disclosure.

### DETAILED DESCRIPTION

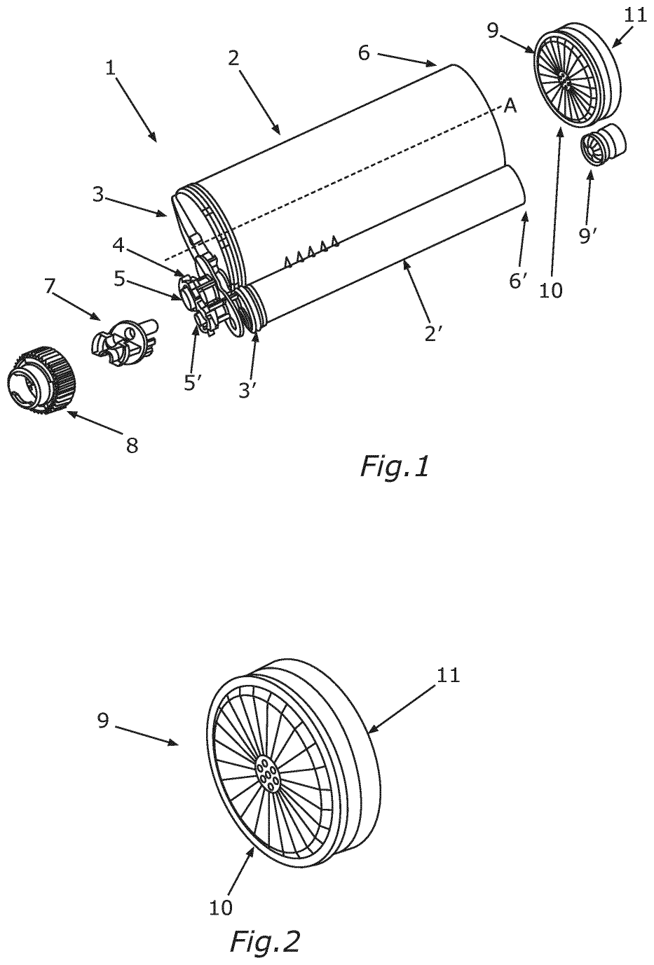

FIG. 1 shows a an example of a cartridge assembly (1) (or short: cartridge) as commonly known in the art. The longitudinal direction (A) of the cartridge (1) is also shown. The cartridge (1) as shown in FIG. 1 can be used in any one of the methods described herein, as a basis for the cartridge according to the fifth aspect of the disclosure, or in combination with the dispenser tip (assembly) according to the seventh or eighth aspect of the disclosure. Alternatively, a cartridge (1) having one chamber (2) or more than two chambers can be used (not shown). The herein shown cartridge assembly is composed of two cartridge chambers (2, 2′) which distinguish from each other in their volumetric capacities. It is possible that the ratio of the volumetric capacities of the two chambers is e.g. 50:1, 25:1, 10:1, 5:1, 2:1, or 1:1. The ratio and thus the size of each chamber can be chosen as required by the intended application of the cartridge assembly. In FIG. 1, the cartridge chambers 2 and 2′ have for example a volumetric capacity ratio of 25:1.

The wall of the cartridge chambers 2, 2′ can be solid or flexible. In particular, both of the chambers 2, 2′ can be solid or flexible. In some methods of the present disclosure, the at least one cartridge chamber is solid. This particularly applies for the method according to the first aspect, where a vacuum is required to empty a cartridge optionally attached to a dispenser tip. With suitably selected vacuum the walls of a solid cartridge do not tend to collapse.

A typical cartridge (1) has a head part (3) which is sealingly and non-releasably mounted on an upper end of the cartridge chamber. With regard to a cartridge assembly as shown in FIG. 1, each one of the cartridge chambers can have a mounted head part (3, 3′). The head parts (3, 3′) can be manufactured in one piece. They can also be fixed to one another after separate manufacturing, for example by click locking two separate head parts (3, 3′) to one another.

As the exemplary cartridge assembly or cartridge (1) has two chambers (2, 2′), an outlet part (4) is provided with two outlets (5, 5′). FIG. 1 shows an outlet part (4) on top of the head part (3, 3′), the outlet part (4) having two outlets (5, 5′) for each filling material inside the cartridge chambers (2, 2′) to be dispensed. It is also possible that a cartridge having one chamber (2) has an outlet part (4) on top of a head part (3), wherein the outlet part has only one outlet (5) for a filling material inside the one chamber (2) to be dispensed.

A cartridge has a lower part (6, 6′) which is situated opposite to the head part (3, 3′) with regard to the longitudinal direction (A) of the cartridge.

FIG. 1 further shows a plug (7) with pins that can be inserted into outlets (5, 5′) to close them during storage. Plug (7) is secured by thread part (8), which also serves to fix an accessory part, such as a dispenser tip (see below) to the cartridge (1).

The cartridge (1) in FIG. 1 further comprises two pistons (9, 9′), one for each cartridge chamber (2, 2′). A cartridge having one chamber (2) can accordingly have one piston (9). The piston (9, 9′), which is also shown in FIG. 2, has a surface (10) facing the head part of the cartridge (3, 3′) and a surface (11) facing the lower part of the cartridge (6, 6′). It is typical to use a plunger having a rod (not shown) in order to move the piston (9, 9′) through the cartridge chamber (2, 2′), i.e., to move the piston (9, 9′) towards the head part (3, 3′) of the cartridge (1) along the longitudinal direction (A) to dispense the material contained in chambers (2, 2′). The piston (9, 9′) can have at least one ventilating opening which can be required for removing air during filling of the cartridge from the head part (3, 3′) side, for example filling via an orifice of the cartridge or an outlet (5, 5′).

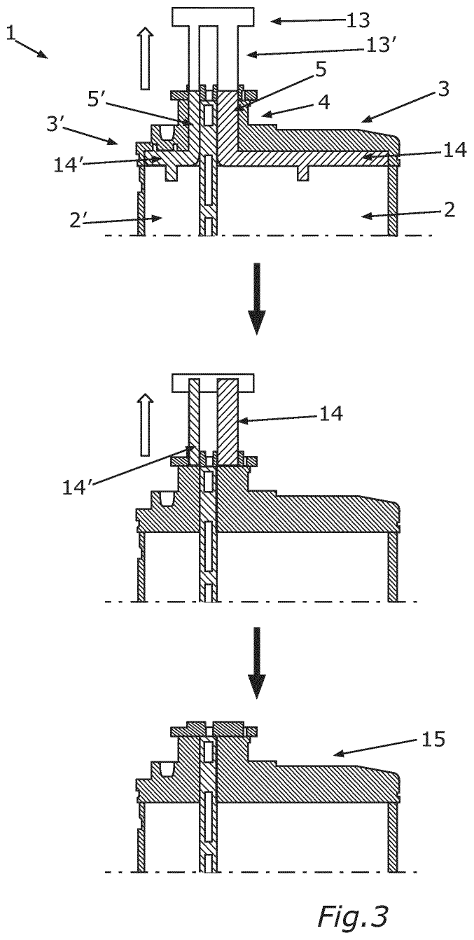

FIG. 3 shows a schematic illustration of an embodiment of the method according to the first aspect of the disclosure. In the top image of FIG. 3, a vacuum device (13) is shown which is connected to the outlet part (4) of a cartridge (1). The cartridge comprises a residual volume amount of a filling material (14, 14′) in both chambers (2, 2′). This connection can be achieved by using an adaptor (13′), such as a plastic tube suitable for vacuum, wherein the adaptor (13′) sealingly connects the vacuum device (13) and the cartridge (1) via the outlet part (4). The adaptor (13′) allows to suck the materials separately from chambers (2, 2′). That way, it can be avoided that the at least two residual materials (14, 14′) interact with each other and/or cure upon contact with each other in the same adaptor (13′).

In the middle image of FIG. 3, a cartridge (1) is shown which is at least partially emptied, i.e., a volume amount of a residual material (14, 14′) stored in each one of the chambers (2, 2′) is at least partially sucked out of the cartridge (1). It is possible that at least a cartridge chamber (2, 2′) is emptied essentially completely, as shown in the middle image of FIG. 3. It is also possible that at least one part of the cartridge chamber (2, 2′) is decontaminated, i.e., a volume amount of a residual material (14, 14′) is removed from at least one part of the chamber (2, 2′). It is also possible that a cartridge chamber (2, 2′) and an outlet (5, 5′) is emptied essentially completely, or, as shown in the middle image of FIG. 3, a cartridge chamber (2, 2′) is emptied essentially completely, whereas an outlet (5, 5′) is at least partially emptied. The degree of decontamination can depend on various factors, such as the nature of the residual material (such as viscosity, adhesiveness), the pressure range used as vacuum, the vacuuming time, the volume amount of the residual material (14, 14′), and the like.

In the bottom image of FIG. 3, an essentially completely emptied cartridge (15) is shown. In this case, the entire cartridge (15) can be subjected to the recycling process, e.g. a cleaning and/or refilling process (see below). In another case, where the cartridge (1) comprises a part which is not essentially completely emptied, such as at least one part of the outlet part (4) comprising a contaminated outlet (5, 5′), the contaminated outlet can be removed from the decontaminated cartridge part, e.g., by cutting. The decontaminated cartridge part can then be recycled, whereas the contaminated cartridge part, such as at least one part of an outlet, can be disposed as commonly known, e.g. as hazardous waste.

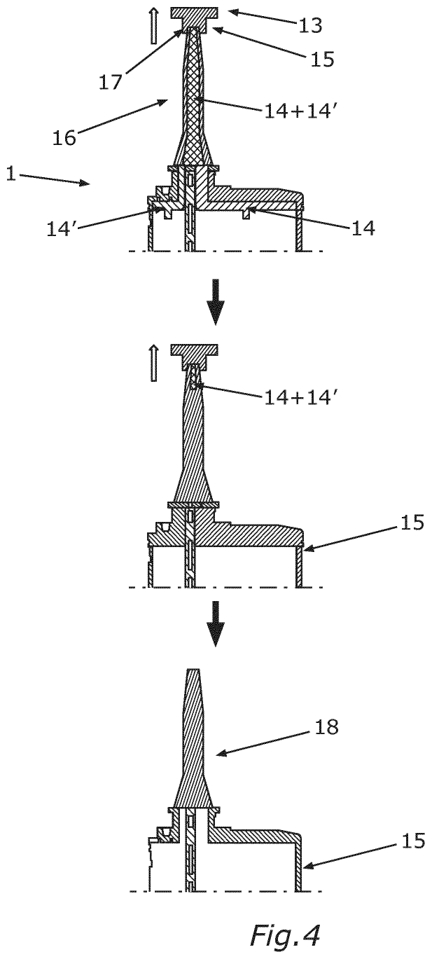

FIG. 4 shows a schematic illustration of an embodiment of the method according to the first aspect of the disclosure for emptying a cartridge (1) and a dispenser tip (16) attached to it. In this embodiment, at least a cartridge (1) is at least partially emptied, while a dispenser tip (16) can optionally be emptied to at least a certain degree. Any known dispenser tip (16) can be used. For example, a dispenser tip (16) comprising a mixer inside can be used which allows at least two filling materials stemming from at least two different cartridge chambers (2, 2′) to mix inside the dispenser tip (16) before dispensing the mixed materials (14+14′). Similar to FIG. 3, the top image of FIG. 4 shows a cartridge (1) filled with a volume amount of residual material (14, 14′). In contrast to FIG. 3, the embodiment shown in FIG. 4 is characterized in that the vacuum device (13) is connected to an outlet (17) the dispenser tip (16). An adaptor (13′) similar to that described in connection with FIG. 3 (albeit with a single channel) can be used. The vacuum device (13) empties at least a part of a volume amount of a residual material (14, 14′) from the cartridge (1) and optionally also the mixed material (14+14′) from the dispenser (16) by sucking.

The middle image of FIG. 4 shows an essentially completely emptied cartridge (15) while the dispenser tip (16) is partially emptied, therefore still comprising a volume amount of a residual amount (14, 14′).

It is also possible that the dispenser tip (16) can additionally be essentially completely emptied, thereby providing an essentially completely emptied cartridge and an essentially completely emptied dispenser tip (18), as shown in the bottom image of FIG. 4. This can depend on the already described factors, such as the nature of the residual material (such as viscosity, adhesiveness), the pressure range used as vacuum, the vacuuming time, the volume amount of the residual material (14, 14′), and the like.

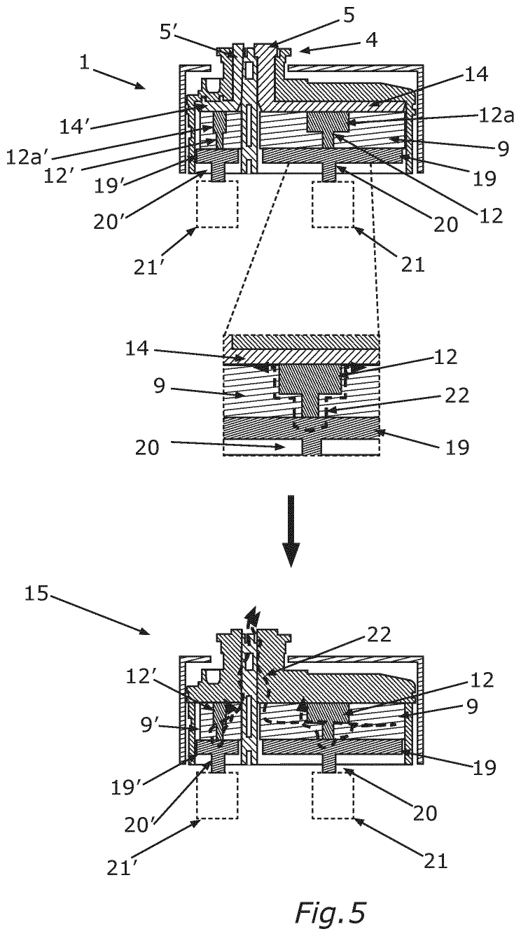

FIG. 5 shows a schematic illustration of an embodiment of the method according to the second aspect of the disclosure for emptying a cartridge (1). The top image of FIG. 5 shows a cartridge (1) connected to a pressurized fluid device (21, 21′) via the plunger (19, 19′), herein: via a rod (20, 20′) of the plunger (19, 19′). In this case, the plunger (19, 19′) and the rod (20, 20′) must be at least partially hollow such that the pressurized fluid (22) can flow from the device (21, 21′) through at least one ventilating opening (12, 12′) inside a piston (9, 9′). However, an alternative or even direct connection of ventilating opening (12, 12′) with device (21, 21′) is conceivable. E.g., it is possible that the device (21, 21′) is connected to the piston's surface facing the lower part of a cartridge (11) (not shown). In this case, the plunger (19, 19′) is be removed from the cartridge (1) in order to expose the surface (11). A pressurized fluid device (21, 21′) can then be connected to the surface (11) for example by using an adaptor (13′) show in FIG. 3 (albeit with a single channel, such as a tube). Device (21, 21′) feeds a flow of a pressurized fluid (22) into cartridge chambers (2, 2′).

Ventilating opening (12, 12′) is closed by a plug element (12a, 12a′) during use or storage. When pressurized fluid is applied to opening (12, 12′) the plug element (12a, 12a′) partially opens the opening (12, 12′) thereby allowing the pressurized fluid to enter chamber (2, 2′).

The magnified image of the top image in FIG. 5 shows an exemplary flow of pressurized fluid (22) through the ventilation opening (12) that passes from surface (11) towards surface (10), thereby flowing through the piston (9). A similar flow can also be provided in piston (9′) of a cartridge assembly. From FIG. 5 is to be understood that the fluid (22) enters and traverses the at least one ventilating opening (12, 12′) substantially in the longitudinal direction (A) of the cartridge. In this context, “substantially in the longitudinal direction (A)” means that there can be sections of the fluid's flow which can not be parallel to the longitudinal direction (A), i.e., angled with regard to the direction (A), for example orthogonally thereto, as shown for piston (9) in the bottom image of FIG. 5. This is because it is possible that a ventilating opening (12, 12′) can extend radially inside a piston (9, 9′). It can also divide into at least two radial channels (not shown) inside the piston. That way, it is possible to distribute the pressurized fluid (22) even if only one orifice of the ventilating opening (12, 12′) is provided on the surface (11). Accordingly, such a radially extending ventilating opening (12, 12′) can have one orifice on the surface (11) and at least two orifices on the surface (10).

In the bottom image of FIG. 5, an essentially completely emptied cartridge (15) is shown which was emptied by urging the residual material (14, 14′) from the cartridge (1) using a pressurized fluid (22) forcefully flowing through a ventilation opening (12, 12′). As already mentioned with regard to the method according to the first aspect of the disclosure, it is possible that a cartridge (1) is at least partially emptied. In this case, the decontaminated part of the cartridge can be separated, e.g., by cutting, in order to subject it to the recycling stream.

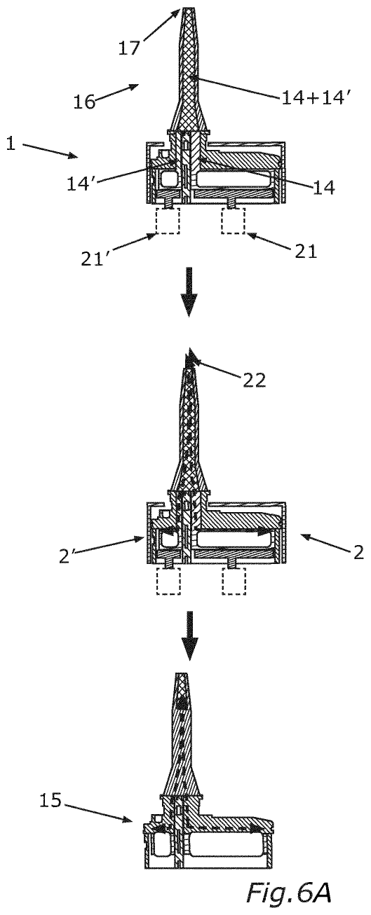

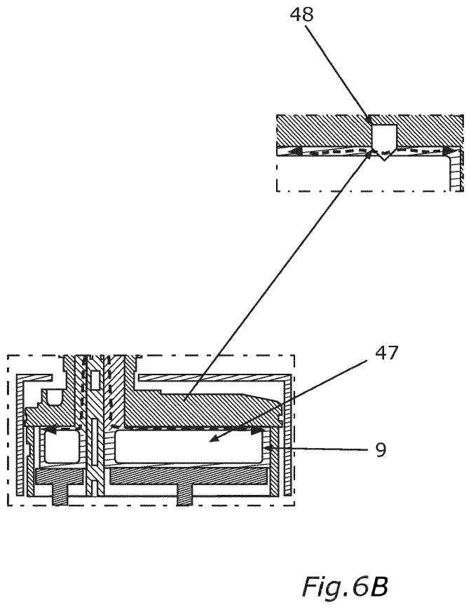

FIG. 6A shows a schematic illustration of an embodiment of the method according to the second aspect of the disclosure for emptying a cartridge and dispenser tip. Similar to the principle described with regard to FIG. 5, a pressurized fluid device (21, 21′) is connected to the cartridge. A ventilating opening (12, 12′) is not shown in FIG. 6A but corresponds to the ones described with regard to FIG. 6A. A pressurized fluid (22) is pressed from the vacuum device (21, 21′) through the piston (9, 9′), the chamber (2, 2′) and then through the dispenser tip (16) connected to the cartridge (1). That way, a residual material (14, 14′) inside a chamber (2, 2′) can be removed via the outlet of the dispenser tip (17). This method provides for cartridge at least partially emptied. The dispenser tip (17) can also be emptied at least partly. The efficiency of the process can depend on the aforementioned factors, such as the nature of the residual material (such as viscosity, adhesiveness), the pressure range used as vacuum, the vacuuming time, the volume amount of the residual material (14, 14′), and the like. It is more facile to provide for an essentially completely emptied cartridge (15) and an essentially completely emptied dispenser tip (16) in case the cartridge has only one chamber (2). This is because that when using a cartridge assembly, it is possible that the residual materials (14, 14′) mix and cure inside the dispenser tip during the emptying process (mixed material (14+14′). In such cases, it is beneficial to use highly pressurized fluids and/or pressurized solvents which allow a faster and/or more efficient removal of the mixture (14, 14′).

Alternatively, in order to prevent a premature curing of a residual material (14) or a mixture thereof (14+14′), in particular when using a cartridge assembly, it is particularly beneficial to combine the methods according to the first and the second aspects of the disclosure (not shown). In this case, a vacuum is applied at an outlet of the dispenser tip (17) and simultaneously a pressurized fluid (22) is introduced through a ventilating opening (12, 12′) of the cartridge (1). However, this combined method can also be required in case the residual material is particularly sticky, so that its removal from a one chambered cartridge can be difficult when using a single method.

FIG. 6B shows a schematic illustration of an embodiment of a cartridge with a piston (9) having a sealed cavity (47) filled with a viscous or fluid material. The term “material” should be construed in a broad way, it also covers a mixture of two or more substances.

The material in the cavity can be a reactant and/or a rinsing fluid and/or a solvent that supports the process of removing the residual material contained in the chamber of the cartridge. It is also conceivable that the material in the cavity is a reactant that helps to cure the residual material, so that the disposal of the emptied cartridge is less problematic. E.g. the material in the cavity (47) can be the material that is in the other chamber of the cartridge.

A cutting element (48) is disposed on the head part (3) of the cartridge (cf. enlarged detail). It extends into the chamber and cuts a surface of the piston (9) as it approaches head part (3). The surface can be provided with a weakened zone that facilitates cutting.

The opening in the surface created by cutting element (48) allows material of cavity (47) to enter the chamber and vice versa. A multitude of elements (48), e.g. arranged in an array and/or having similar or varying shapes, can be provided to facilitate the flow of material. Element(s) (48) can be provided with flow directing properties, such as curved and/or angled sections, that direct the flow of material appropriately and/or the facilitate the mixture of the material in the chamber and in the cavity.

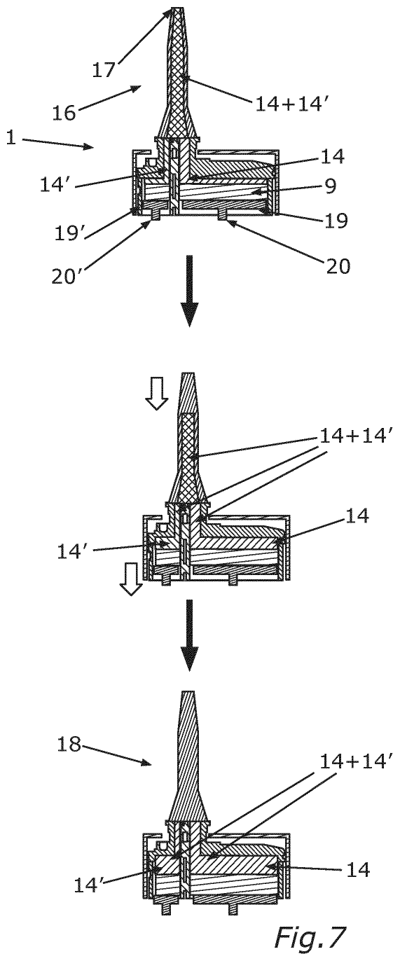

FIG. 7 shows a schematic illustration of an embodiment of the method according to the fourth aspect of the disclosure for a dispenser tip (16). In principle, this method is based on pulling back the piston (19, 19′) towards the lower part of the cartridge (6, 6′). The piston (9, 9′) can be pulled back by pulling a rod (20, 20′) of a plunger (19, 19′), wherein the piston (9, 9′) is attached to the plunger (19, 19′). The mixed material (14+14′) inside the dispenser tip (16) can at least partially be urged into the cartridge; see middle image of FIG. 7. A further pulling of the piston (9, 9′) towards the lower part of the cartridge (6, 6′) can provide an essentially completely emptied dispenser tip (18); see bottom image of FIG. 7. The emptied dispenser tip (18) can be recycled as non-hazardous waste. Furthermore, because the amount of the already mixed material (14+14′) pulled from the dispenser tip (16) into the cartridge (1) can lead to curing of the residual material (14) and/or (14′) inside the chambers (2, 2′) and/or the outlets (5, 5′). FIG. 7 is to be understood such that the mixed material (14+14′) provide a top layer on a bottom layer containing a residual material (14) or (14′). Depending on the nature of the materials, a partial mixture at the interface between the layers can occur.

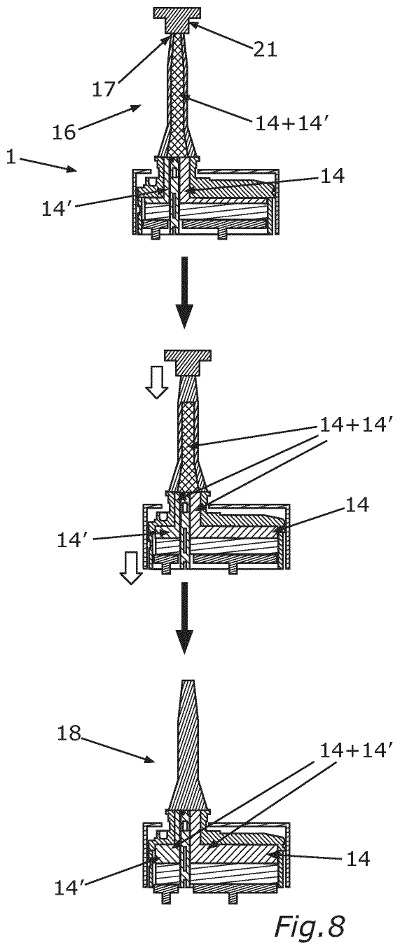

FIG. 8 shows a schematic illustration of an alternative embodiment of the method according to the fourth aspect of the disclosure for a dispenser tip (16). Similar to the embodiment shown FIG. 7, an essentially completely emptied dispenser tip (18) can be provided. In the embodiment shown in FIG. 8 this can be achieved by attaching a pressurized fluid device (21) to the outlet of the dispenser tip (17) so that a pressurized fluid (22), such as compressed air or pressurized solvent, can urge the (mixed) material (14+14′) from the dispenser tip into the cartridge.

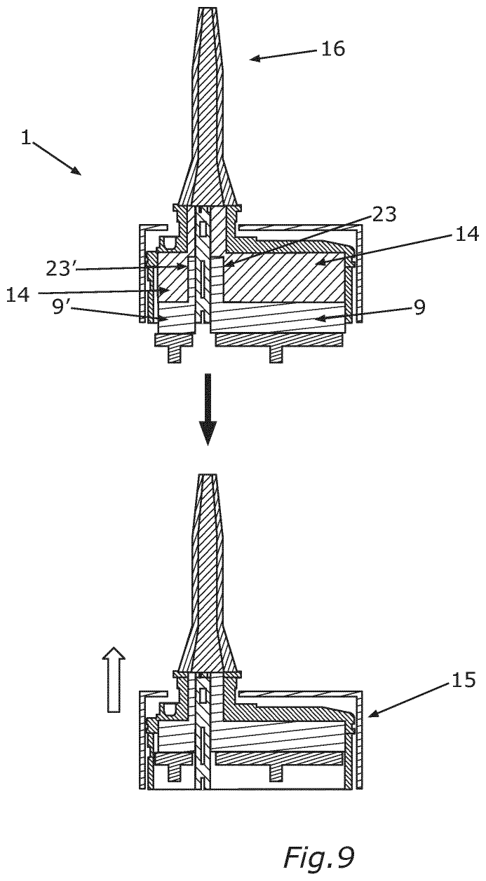

FIG. 9 shows a schematic illustration of an embodiment of the cartridge according to the fifth aspect of the disclosure. In this embodiment, the cartridge (1) has pistons (9, 9′) each of which is provided with a protrusion (23, 23′). The protrusion (23, 23′) is situated below and aligned with the associated outlet (5, 5′). It further has a cross-sectional shape matching that of the outlet (5, 5′). That way, the protrusion (23, 23′) can fit in the outlet (5, 5′) in order to urge a residual material (14, 14′) from the chamber (2, 2′) and/or the outlet (5, 5′) out of the cartridge. FIG. 9 shows a cartridge (1) attached to a dispenser tip (16). This is possible but not essential for the cartridge according to the fourth aspect of the disclosure. In particular, in case a piston (9, 9′) has a protrusion (23, 23′) having a length equal to or larger than the length of the outlet (5, 5′), then a larger volume amount of residual material (14, 14′) can be removed from a cartridge (1), thereby providing an essentially completely emptied cartridge (15); see FIG. 9.

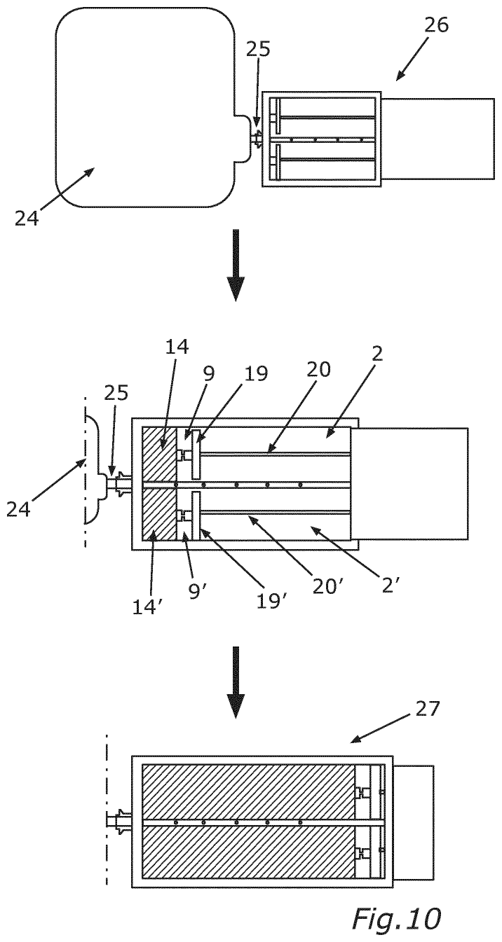

FIG. 10 shows a schematic illustration of an embodiment of the method according to the sixth aspect of the disclosure for providing a refilled cartridge (27). An at least partially spent cartridge (26) comprising a predetermined volume amount of a residual material can be attached to a refilling system (24), such as a barrel having a docking station and being filled with the required filling material, by using a filling adaptor (25); see top image of FIG. 10. As shown in the middle image of FIG. 10, then pistons (9, 9′) of cartridge (26) are pulled towards the lower part of the cartridge (6, 6′) so as to suck a volume amount of the filling material into chambers (2, 2′). They can be pulled manually or by a suitable device, e.g. by pulling the rods (20, 20′) of plungers (19, 19′). Alternatively or additionally, pistons (9, 9′) can be pushed in reaction to the application of a pressurized filling material provided by refilling system (24). These methods of refilling can be easily performed at construction sites, when storage tanks with the material(s) needed are provided.

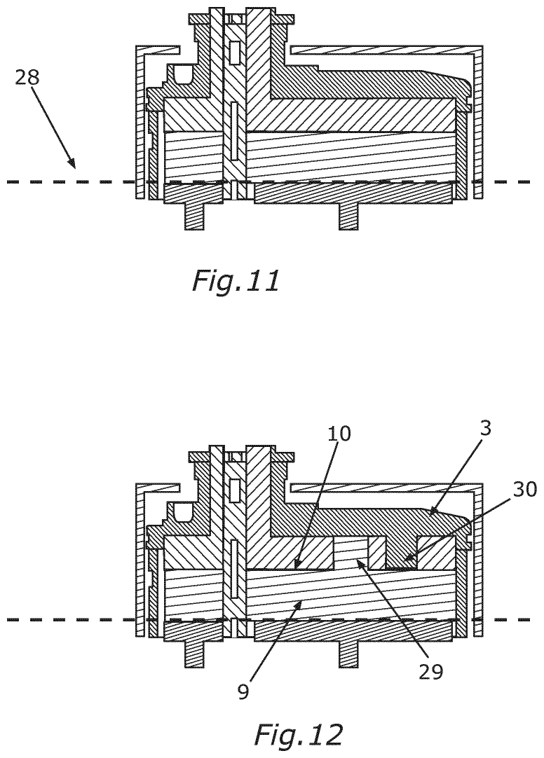

According to an embodiment of the method described above and not shown in the top image of FIG. 10, the at least partially spent cartridge (26) to be refilled comprises at least a predetermined volume amount of a residual material. That way, it can be avoided that air bubbles can interfere the refilling process. Providing a cartridge (26) which is not fully dispensed but comprises a predetermined amount of a residual material prevents that air is filled into the chambers (2, 2′) together with the refilling material. Such a cartridge (26) can be provided by defining a stopping position (28) until which the piston (9, 9′) is able to move towards the head part (3, 3′) of the cartridge, and wherein the piston is not able to move beyond the stopping position. The stopping position is shown in FIG. 11.

For example, a stopping position (28) can be defined by using a piston having a rod (20, 20′) which has a smaller length than the length of the cartridge chamber (2, 2′), wherein the length is defined with regard to the longitudinal direction (A) (not shown).

Alternatively, or in addition thereto, it is possible to use a piston which has a stopping element (29, 30), such as a protrusion (29) extending from the surface (10) towards the head part (3), and/or a protrusion (30) extending from the head part (3) towards the surface (10) of the piston (9), as shown in FIG. 12. The extension of the protrusion (29, 30) can be chosen as required for a specific volume amount of residual material not to be dispensed from the cartridge. It is obvious that the stopping element (29, 30) is preferably not situated directly below the outlet (5, 5′) with regard to the longitudinal direction (A).

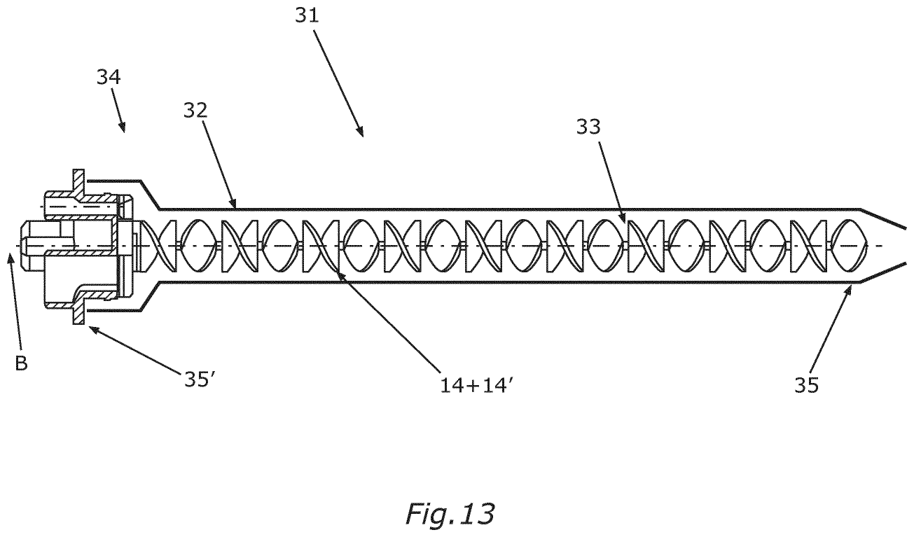

FIG. 13 shows a dispenser tip (31) according to the seventh aspect of the disclosure, the dispenser tip comprising a mixer (33) and a sheath (32) which covers the mixer (33) in a circumferential direction with regard to the longitudinal axis of the dispenser tip (B). The sheath is flexible and extends from a second end (34) to a first end (35) of a dispenser tip with regard to the axis (B). The mixer (33) is releasably or non-releasably fixed to a connecting part (35′), wherein the connecting part (35′) can be connected to an outlet part (4) of a cartridge (1). The connecting part (35′), comprises at least two separate channels, each having an inlet opening associated with one of a first outlet opening (5) or a second outlet opening (5′) of the outlet part (4) and having an outlet opening associated with the mixer (33) which is also shown in FIG. 1.

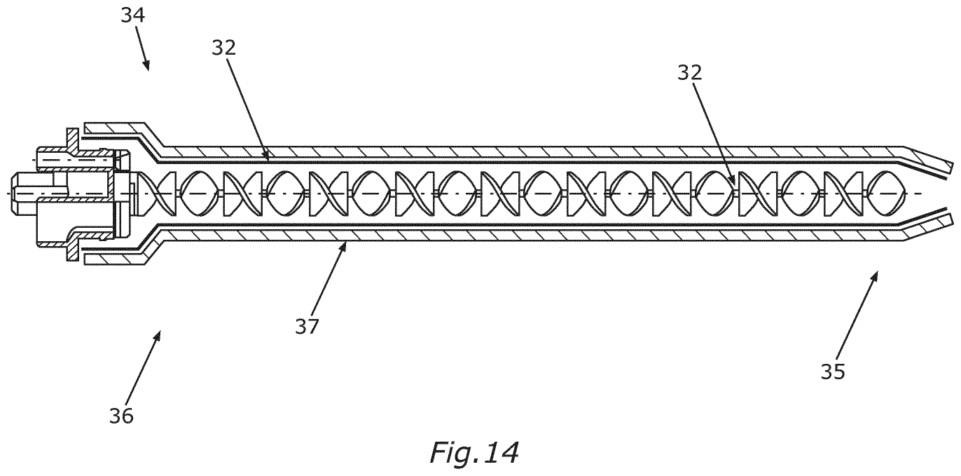

FIG. 14 shows a dispenser tip assembly (36) according to the eighth aspect of the disclosure, wherein the dispenser tip assembly comprises a support sleeve (37) and a dispenser tip (31) according to the sixth aspect of the disclosure. As can be seen in FIG. 14, the wall thickness of the support sleeve (37) is larger than the one of the mixer sheath (32). The support sleeve (37) mainly acts as mechanical support for the flexible mixer sheath inside. In contrast to the mixer sheath (32), the support sleeve (37) is not in direct contact with the mixed material to be dispensed (14+14′) so that the support sleeve can be reused multiple times. The flexible mixer sheath can be disposed as (non-)hazardous waste, depending on the content. In order to prevent a contamination of the support sleeve (37) with the material (14+14′), the mixer sheath (32) the length of the mixer sheath (32) can be greater than the length of the support sleeve (37), wherein the exposed surplus in length extends from the first end of the dispenser tip (35), thereby covering the first end side (35) of the support sleeve (37), not shown in FIG. 14. In order for the dispenser tip assembly (36) to fixedly hold the mixer sheath (32), it is possible that at the second end thereof (34) at least one portion of sheath is exposed such that it can be clamped between the support sleeve (37) and the connecting part (7, 8), as shown in FIG. 14.

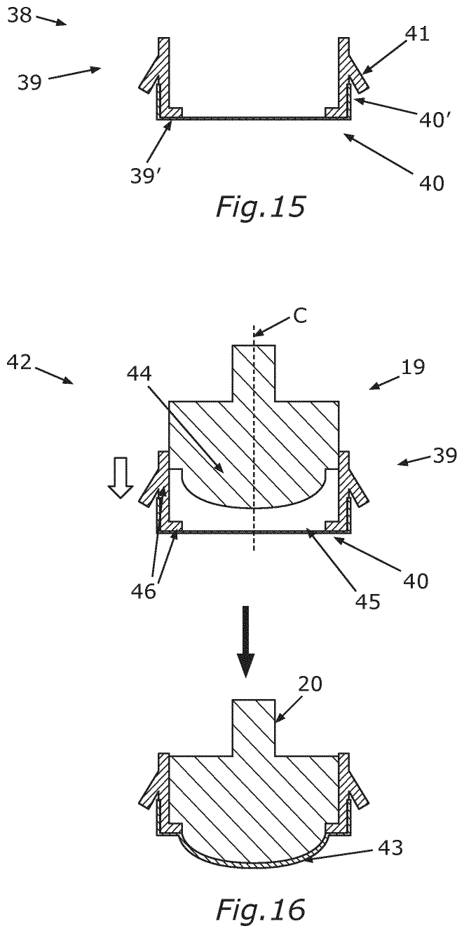

FIG. 15 shows a schematic illustration of an embodiment of a hybrid piston (38) according to the ninth aspect of the disclosure. The hybrid piston comprises a rigid ring part (39) defining a side wall of the piston and a flexible head part (40) defining a top surface of the piston. Head part (40) forms a top surface (39′) of the piston. In addition thereto, the head part (40) partially covers the side wall of the piston (overlap 40′). The ring part is provided with a sealing lip (41) that cooperates in use with the sidewall of chamber (2, 2′).

FIG. 16 shows a schematic illustration of an embodiment of a hybrid piston assembly (42) according to the tenth aspect of the disclosure. In the top image of FIG. 16, a plunger (19) is shown having a dome-shaped leading surface (44). When the plunger (19) is pushed into ring part (39), the leading surface (44) deforms a section of the head part (40) exposed due to an aperture (45) in a head face of the ring part (39). As soon as shoulder (46) of plunger (19) contacts shoulder (46) of head part (40), any further axial movement of plunger (19) results in an axial movement of piston (38) that eventually leads to the dispensing of the material contained in the respective chamber (2, 2′).

As head part (40) protects ring part (39) from the material, ring part (39) can be reused after head part (40) has been removed. Since head part (40) does not need to be particularly stable as the mechanical stability of the assembly (42) is provided by ring part (39) cooperating with plunger (19), it can be minimized as regards its mass in order to reduce the amount of waste.

The geometry of the head part of a chamber of a cartridge in which the above-mentioned hybrid piston assembly (42) is used can match the geometry of the leading surface (44) so as to minimized the amount of residual material in the chamber when the cartridge is completely spent.

It should be understood that the hybrid piston concept also works with a plunger (19) with an essentially flat leading surface (44). In turn, the concept of providing a piston assembly with a non-flat (e.g. convex) geometry can be used independently of the hybrid piston concept.

1. A method of emptying a cartridge to be recycled, the method comprising:
providing a cartridge filled with a volume amount of a residual material to be removed from the cartridge, the cartridge comprising a solid head part having an outlet part forming an outlet; and
applying a vacuum to the cartridge by a vacuum device, thereby removing at least a part of the residual material from the cartridge.

2. The method according to claim 1, wherein the residual material is removed from the cartridge via a dispenser tip attached to the outlet part of the cartridge.

3. The method according to claim 1, wherein the vacuum is applied until the cartridge is essentially completely emptied.

4. The method according to claim 1, further comprising connecting a vacuum device to the outlet part of the cartridge, or to an outlet of a dispenser tip attached to the outlet part of the cartridge after providing a cartridge and prior to applying a vacuum to the cartridge.

5. A method of emptying a cartridge to be recycled, the method comprising:
providing a cartridge filled with a volume amount of a residual material to be removed from the cartridge, the cartridge comprising a solid head part having an outlet part forming an outlet, a lower part opposite to the head part with regard to a longitudinal direction of the cartridge, and a piston moveable through the cartridge, the piston having at least one ventilating opening extending between a surface facing the head part and a surface facing the lower part; and
applying a pressurized fluid through the at least one ventilating opening by a pressurized fluid device, thereby urging and removing the residual material from the cartridge.

6. The method according to claim 5, wherein the residual material is removed from the cartridge via a dispenser tip attached to the outlet part of the cartridge.

7. The method according to claim 5, wherein the pressurized fluid is applied until the cartridge is essentially completely emptied.

8. The method according to claim 5 further comprising connecting a pressurized fluid device to the ventilating opening of the piston after providing a cartridge and prior to applying a pressurized fluid.

9. The method of emptying a cartridge to be recycled according to claim 1 and wherein, the cartridge includes a lower part opposite to the head part with regard to a longitudinal direction of the cartridge, and a piston moveable through the cartridge, the piston having at least one ventilating opening extending between a surface facing the head part and a surface facing the lower part, and further comprising applying a pressurized fluid through the at least one ventilating opening by a pressurized fluid device, thereby urging and removing the residual material from the cartridge.

10. A method of emptying a dispenser tip to be recycled, the method comprising:
providing a dispenser tip attached to an outlet part of a cartridge, the dispenser tip being filled with a volume amount of a residual material to be removed from the dispenser tip, the cartridge comprising a solid head part having an outlet part forming an outlet and a lower part opposite to the head part with regard to a longitudinal direction of the cartridge, the cartridge further comprising a piston moveable through the cartridge;
pulling the piston towards the lower part of the cartridge, thereby re-moving the residual material from the dispenser tip into the cartridge; or
connecting an outlet of the dispenser tip to a pressurized fluid device, and applying a pressurized fluid by the pressurized fluid device through the dispenser tip, thereby urging the residual material from the dispenser tip into the cartridge.

11. The method according to claim 1, wherein
the cartridge comprises a volume amount of the residual material of from about 1% to about 50%, based on a total volume of the cartridge, or
the dispenser tip comprises a volume amount of the residual material of from about 60% to about 100%, based on a total volume of the dispenser tip.

12. The method according to claim 2, wherein the dispenser tip comprises a mixer.

13. A cartridge, comprising:
a solid head part having an outlet part forming an outlet;
a lower part opposite to the head part with regard to a longitudinal direction of the cartridge;
a piston moveable through the cartridge in the longitudinal direction, the piston having a surface facing the head part and a surface facing the lower part, the piston comprising a protrusion extending from the surface facing the head part, the protrusion being aligned with the outlet and having a cross-sectional shape matching a cross sectional shape of the outlet so as to be insertable into the outlet by a movement of the piston to remove residual material from the outlet part of the cartridge.

14. The cartridge according to claim 13, wherein the protrusion has an extension in the longitudinal direction at least equal to an extension of the outlet of the cartridge.

15. A method of refilling an at least partially spent cartridge, the method comprising:
providing the at least partially spent cartridge comprising a predetermined volume amount of a residual material, a solid head part having an outlet part forming an outlet and a lower part opposite to the head part with regard to a longitudinal direction of the cartridge, the cartridge further comprising a piston moveable through the cartridge in the longitudinal direction, the piston having a surface facing the head part and a surface facing the lower part;
connecting the outlet part to a refilling system comprising a refill material; and
pulling the piston towards the lower part, thereby sucking the refill material so as to provide a refilled cartridge; or urging the piston towards the lower part by pressing the refill material into the cartridge so as to provide the refilled cartridge.

16. The method according to claim 15, wherein the partially spent cartridge is provided with at least a predetermined volume amount of a material in the cartridge by limiting the movement of the piston towards the head part in a stop position during a process of dispensing the cartridge.

17. The method according to claim 16, wherein the movement of the piston is limited in the stop position by providing a dispenser receiving the cartridge, the dispenser comprises at least one movable plunger cooperating with the piston so as to be movable in the longitudinal direction, and the plunger or a device driving the plunger is configured such that the piston is not movable beyond the stop position.

18. The method according to claim 16, wherein the head part or the piston comprises at least one protrusion extending towards the piston or the head part, respectively, an extension of the at least one protrusion in the longitudinal direction defining the stop position.

19. The method of claim 16, wherein the predetermined volume amount of a residual material in the cartridge is in the range of from about 30% to about 1%, based on a total volume of the cartridge.

20. A dispenser tip comprising:
a mixer; and
a mixer sheath, the mixer comprising a first end and a second end opposite to the first end with regard to a longitudinal axis of the dispenser tip, the mixer sheath covering the mixer in a circumferential direction and formed by a flexible or thin-walled rigid material.

21. The dispenser tip according to claim 20, wherein the flexible material is selected from the group consisting of a paper or a polymer film.

22. The dispenser tip according to claim 20, wherein the tip further comprises a connecting part non-releasably or releasably connected to the mixer, the connecting part being configured to be connected to an outlet part of a cartridge.

23. The dispenser tip according to claim 22, wherein the sheath is connected to the connecting part.

24. The dispenser tip according to claim 22, wherein the connecting part comprises at least two separate channels, each of the at least two separate channels having an inlet opening associated with one of a first outlet opening or a second outlet opening of the outlet part and having an outlet opening associated with the mixer.

25. A dispenser tip assembly comprising:
a rigid support sleeve comprising a first end and a second end opposite to the first end with regard to a longitudinal axis of the dispenser tip, the support sleeve being configured to receive at least the part of the dispenser tip according to claim 22.

26. The dispenser tip assembly according to claim 25, wherein a wall thickness of the mixer sheath is smaller than a wall thickness of the support sleeve.

27. The dispenser tip assembly according to 25, wherein the sup-port sleeve is releasably or non-releasably connected to the connecting part.

28. The dispenser tip assembly according to claim 25, wherein at least one portion of the sheath is disposed between the support sleeve and the connecting part.

29. The dispenser tip assembly according to claim 25, wherein the support sleeve includes at least one stop element cooperating with the mixer or with the connecting part so as to limit a relative axial movement of the mixer or of the connecting part during use of the tip assembly.

30. A hybrid piston comprising:
a hollow rigid ring part defining a side wall of the piston that is configured to cooperate with an inner sidewall of a cartridge; and
a head part defining a top surface of the piston, the head part being disposed on the ring part, the ring part and the head part being sealingly and releasably or fixedly connected to one another.

31. The hybrid piston according to claim 30, wherein an outer surface section of the ring part is connected to an inner surface section of the head part.

32. The hybrid piston according to claim 30, wherein the a wall thickness of the head part is smaller than the a thickness of the ring part or the head part is made of a more stable or rigid material than the head part.

33. The hybrid piston according to claim 32, wherein a ratio of the wall thickness of the flexible part to the wall thickness of the rigid part is 0.5 or less.

34. A hybrid piston assembly comprising:
a plunger configured to be positioned in the hollow ring part of the hybrid piston according to claim 30, and the plunger comprises a leading surface configured to be brought into contact with a surface of the head part, the leading surface having a non-flat geometry.

35. The hybrid piston assembly according to claim 34, wherein the leading surface is convex.

36. The hybrid piston assembly according to claim 34, wherein the leading surface is configured to deform the head part of the hybrid piston elastically or plastically during use of the hybrid piston assembly.

37. A cartridge, comprising:
at least one chamber having a head part having an outlet part forming an outlet and a lower part opposite to the head part with regard to a longitudinal direction of the cartridge;
a piston moveable through the cartridge in the longitudinal direction, the piston comprising at least one sealed cavity containing a viscous or fluid material; and
an unsealing device configured to open the cavity such that the material of the cavity is capable of flowing into the chamber and vice versa.
